(19) United States
(12) Patent Application Publication
(10) Pub. No.: US 2015/0142144 A1
(43) Pub. Date: May 21, 2015

(54) LABEL AND SYSTEM FOR INFANT CARE HAVING PROVISION FOR AUTOMATIC UPDATING

(71) Applicant: SwaddleDesigns LLC., Tukwila, WA (US)

(72) Inventors: Lynnette Damir, Tukwila, WA (US); Jeffrey Damir, Tukwila, WA (US)

(21) Appl. No.: 14/046,137

(22) Filed: Oct. 4, 2013

Related U.S. Application Data
(60) Provisional application No. 61/709,862, filed on Oct. 4, 2012.
(60) Provisional application No. 61/709,872, filed on Oct. 4, 2012.

(51) Int. Cl. G06F 3/16; G06F 17/30

(52) U.S. Cl. CPC G06F 3/165; G06F 17/3074
USPC 700/94

(57) ABSTRACT

A method and system for providing suitably audio programmatic material for enhancing a baby's experience in distinct contexts employs a connected device having communicative access to a WAN and further includes a camera capable or reading a QR code and responding to instructions contained thereon. The system includes a media player device. The media player device has a central processor connected to a bus and a memory for storing instructions and audio information in a nonvolatile form for the central processor to read through the bus. An audio signal processor to produces sounds based upon audio information stored in memory. A radio transceiver facilitates wireless communication with the connected device. A label bears a QR code including a URL such that upon scanning that QR code with the camera, the connected device connects to the resources located at the URL.

### PRIORITY CLAIM

This application claims priority from two prior provisional applications having inventors Lynnette Damir and Jeffrey Damir of Seattle Wash. and having application No. 61/709,862 and 61/709,872 both dated 4 Oct. 2012; and each are incorporated in full by this reference.

### BACKGROUND OF THE INVENTION

It is very important for parents to learn and practice safe sleep techniques. When parents and caregivers understand the calming techniques and safe sleep practices, baby will sleep better and longer, baby will be safer, and the parents are less likely to suffer from parental exhaustion. After 20 years, the Back to Sleep program in the USA has reduced the number of baby deaths caused by SIDS by over 50% and saved tens of thousands of babies lives, however, babies still needlessly die because parents place baby in unsafe environments, because parents are unaware of the newborn care and safe sleep guidelines. Parental exhaustion is a serious issue because it is a primary contributor to numerous serious problems and grave scenarios. For example parental exhaustion can contribute to or increase the likelihood of depression, nursing failure, child abuse and shaken baby syndrome, SIDS/suffocation, excess medical doctor and ER visits, over treatment for acid reflux, parental smoking, car accidents, and marital strife.

Most parents need to be shown multiple times how to implement calming techniques inclusive of safe swaddling, and they need the safe sleep guidelines available at their fingertips. Forgetting one aspect of the safe sleep guidelines can have grave consequences. Hence, it is critical that parents understand the guidelines, the facts, and the up-to-date information in order to make informed choices when caring for and preparing their baby for sleep.

Studies have shown that calming techniques including swaddling and use of white noise in baby's room will increase duration of baby sleep and reduce awakenings. Unfortunately, parents struggle to emulate and recall the relevant teachings. Further, studies indicate that lullabies have very specific benefits which are proven to have extraordinary benefits for newborns.

Studies conducted, for example, by Dr. Jeffery Perlman, chief of newborn medicine at New York—Presbyterian Hospital's Komansky Center for Children's Health, find that gentle music therapy not only slows down the heart rate of prematurely delivered babies but also helps them feed and sleep better. This helps them gain weight and speeds their recovery. A study published in May of 2013 in the Journal of the American Academy of Pediatrics under the aegis of the Beth Israel Medical Center in New York City found that the type of music matters. Therapeutically designed “live” music—and lullabies sung in person—can influence cardiac and respiratory function.

Another study published in February 2011 in Arts in Psychotherapy by Jayne M. Standley of the National Institute for Infant and Child Medical Music Therapy at Florida State University suggests that babies who receive this kind of therapy leave the hospital sooner.

Further, in most instances when a baby is fussing or crying, parents will not have readily available the suitable text and diagrams to walk through the calming act of swaddling the infant. In fact, most texts showing those steps are, themselves, somewhat awkward to handle when in the act of swaddling. Additionally, while largely the same, some adjustments are appropriate as the infant grows, especially as to the placement of the child on the blanket What is missing in the art, then, is a ready way to provide struggling parents with any of audio programming such as lullabies, or, where the context of the situation (as provided by QR scans) suggests, video or audio presentation in a manner and through a platform convenient to the parent when holding a baby, trying to console a baby, or when trying to swaddle. Further, there is no contextually specific selection of audio programming available that causes selection of programming from a library of soothing sounds such as music, or white noise to calm a fussy baby.

### BRIEF DESCRIPTION OF DRAWINGS

Embodiments of the invention are illustrated in drawings this specification comprises, including:

FIG. 1 is an exemplary embodiment of a label comprising an enabling QR code to drive a browser to a URL site;

FIG. 2 is an exemplary embodiment of a plush toy having a media player device within it;

FIG. 3 is an exemplary embodiment of a blanket having a QR label for providing context;

FIG. 4 is an exemplary embodiment of a system for infant care.

### SUMMARY OF THE INVENTION

Blankets, sleepwear and, especially, plush toys will bear either a label or an emblazoned QR code. When using a mobile device, a user captures the code, and in response, the mobile device will begin to present on-demand a cloud-based, multi-media information program for parents who desire the relevant information that they need and when they need it. As a society, young adults, and, thus, young parents, expect everything to be available “on demand” with minimal effort. The use of the QR code enables the parent to fulfill that need for programmatic material “on demand” especially for harried parents.

The QR code can be tailored for the specific item on which the QR code resides, for example scanning the QR code on the blanket will cause a multimedia educational component to run on a mobile device, or even a laptop or desktop connected device and to access a cloud-based server to stream calming audio sounds collectively referred to herein as “audio programming” or “programmatic material.” By simply reading a QR code, the user will cause the mobile device to access a remote cloud-based server with up-to-date instructional videos and information that can be instantly retrieved and displayed by the mobile device or connected device. In a further embodiment of the invention, the QR code will send programmatic material to a media player device embedded in a plush toy or nursery accessory.

The media player device may include at least one input device such as the mobile device or connected device, the device being configured to receive input from a user, through an application having a communication interface resident on the mobile device, and in communication with the media player device and to generate a signal based upon user input to control the device. The communication interface is configured to reside in nonvolatile memory in the mobile device or other connected device. When the user activates the interface, will selectively connect the media player device to control the media player device to receive programmatic content from an active page on the Internet, through either of the mobile device or other connected device or a distinct wireless device such as a wireless router exploiting an IEEE 802.11 protocol. It is that communication interface that removes the need for a keyboard or pointing apparatus on the media playing device, making the media playing device safer and more reliable in the presence of the baby.

The QR code that is available by virtue of being sewn as a label or permanently emblazoned onto a blanket, nursery accessory, or plush toy and thereby to allow parents to retrieve relevant instructional videos, educational descriptions that will increase their skill level when swaddling their baby and increase their understanding of safe sleep practices as they prepare to place their baby in a crib for sleep.

In addition, the cloud-based service with QR navigation to relevant information approved by leading experts will educate parents of the importance of a smoke free environment, placing baby on his or her back and on a firm surface, and other important safe sleep guidelines. The need for this innovation is amplified because, today, new parents have a Google mindset—that they can search for information when they need it, instead of studying and learning the related information a priori. Furthermore, this innovation will address another problem that the medical community has struggled to address—how to deliver related, up-to-date, recommendations and medical information to parents when they interested and receptive to the teachings.

This novel system, comprising an interface and a label on a blanket, an nursery accessory or a plush toy, promises to save lives and help new parents avoid the serious negative consequences related to parental exhaustion caused by a fussy baby that has trouble sleeping.

### DETAILED DESCRIPTION OF THE PREFERRED EMBODIMENT

Embodiments of the instant invention include blankets, sleepwear, bedding and toys emblazoned with interactive quick response or scan-able codes linked to a specific internet Uniform (or Universal) Resource Locator (URL). As used in the current application, the term “emblazoned” may include, not merely the printing upon the blankets, sleepwear, bedding and toys but instead, placing the same image upon a hang tag or label affixed to the product. In preferred embodiments the term “scan-able code” refers to any two dimensioned bar code including but not limited to a QR code or other scan-able code that links to an internet URL to provide further product features, such as, but not limited to downloadable audio or video media. Wherever, throughout this application, the term “interactive codes” shall mean “scan-able codes” and will include as the presently preferred embodiment, the QR code, but will include any two dimensioned bar type code that directs mobile device users or users of any computing device with optical scanner element to scan the code and be linked to both static data that is typically hosted by bar codes, and or specific internet URLs that can host data that includes text, audio or video, in a downloadable format collectively referred to herein as “mobile device”.

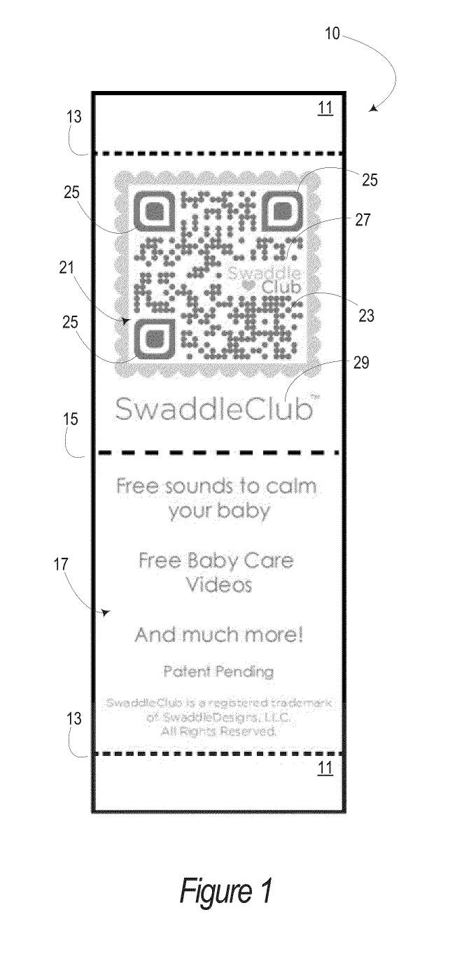

Referring now to FIG. 1, as depicted, an exemplary embodiment of the present invention further provides users with a narrowly specialized use of internet URL information embedded in QR codes or similar scan-able codes (as well known in the art, e.g., US patent/application publications: U.S. Pat. No. 6,637,662, US20080309976, U.S. Pat. No. 6,494,375, entirely incorporated herein by reference) as associated with specific media for downloading to the mobile device:
a) QR (quick response) internet URL codes or similar internet URL codes can be used in or on any product, packaging;
b) QR (quick response) or similar scan-able URL codes can be printed directly on products, printed on labels, printed on tags, molded in, embossed in, or hot stamped in.

In the presently preferred embodiment a label 10, of a conventional substrate 11 bisected at a midpoint by a fold 15 and affixed to a good along stitch lines 13 to the blanket, nursery accessory, or plush toy. The label 10 comprises an informational placard 17 bearing information as to manufacturer, any notices relative to intellectual property rights, and, importantly, an indication of the purpose of the label, explaining the reason for the label 10 and what resources will be available using the label.

The functional portion of the label 10, shown here above the midline fold 15, comprises a scan-able code is the QR Code (abbreviated from Quick Response Code) 21. The QR code is a type of matrix barcode (or two-dimensional code) first designed for the automotive industry. Originally invented in Japan by the Toyota subsidiary Denso Wave in 1994, Toyota used the QR Code 21 to track vehicles during the manufacturing process. Advantageously, the QR code is 21 multiply redundant and therefore is designed to allow components to be scanned at high speed. More recently, the system has become popular outside the industry due to its fast readability and large storage capacity compared to standard UPC barcodes.

The code consists of black modules (square dots) 23 arranged in a square pattern on a white background. The information encoded can be made up of four standardized kinds (“modes”) of data (numeric, alphanumeric, byte/binary, Kanji), or through supported extensions, virtually any kind of data. Unlike the older one-dimensional barcode that was designed to be mechanically scanned by a narrow beam of light, the QR code is detected as a 2-dimensional digital image by a semiconductor image sensor and is then digitally analyzed by a programmed processor. The processor locates the three distinctive squares 25 at the corners of the image, and optionally uses a smaller square near the fourth corner to normalize the image for size, orientation, and angle of viewing. The modules 23 are then converted to binary numbers and validity checked with an error-correcting code. Many users are familiar with the use of QR codes 10 to drive a browser to a particular URL in conjunction with a user's use of the mobile device applications. Since QR Code carries information both horizontally and vertically, QR Code is capable of encoding the same amount of data in approximately one-tenth the space of a traditional bar code. (For a smaller printout size, Micro QR Code is available.)

QR Code 10 has error correction capability and inherent redundancy. Data can be discerned even if the symbol is partially dirty or damaged. A conventional algorithm can restore up to a maximum of 30% of damaged codewords. A codeword is a unit that constructs the data area. In the case of QR Code, one codeword is equal to 8 bits. Data restoration may not be fully performed depending on the amount of dirt or damage. Nonetheless, QR code data is relatively durable even in harsh or dirty environs. In fact, as shown here, a portion of the code data can be readily removed and replaced with a logo 27.

Optionally, the label may include additional information such as material content and washing instructions. In this exemplary instance, the label 10 includes a trademark 29 along with the QR code 10.

Additionally, a QR Code 10 is capable of 360 degree (omni-directional), high speed reading, making it perfect for scanning by smartphone or other mobile device without a rigid copy stand to support it. QR Code 10 accomplishes this quality of readability through position detection patterns 25, set as monuments within the QR code 10 located at the three corners of the symbol. These position detection patterns guarantee stable high-speed reading, circumventing the negative effects of background interference.

Users with a mobile device equipped with a camera and loaded with the correct reader application can scan the image of the QR Code 10. Conventionally, users exploit the reader application to drive a browser to display text, contact information, connect to a wireless network, or open a web page in the telephone's browser. This act of linking from physical world objects is termed hardlinking or object hyperlinking.

In practice, distinct QR codes can be attached to each of the nursery accessories to give context to the moment for which a soothing sound is requested. In practice, for example, a baby bottle might have a label and the scanning of that label would evoke a response of white noise selected to soothe a baby in the course of feeding. A distinct label on a blanket would evoke a lullaby or nature sounds known to aid in the onset of sleep. Still another label affixed to a playpen would trigger a distinct selection of audio programming that would be consistent with quiet play. Further study would yield further opportunities for “marking” with labels. A parent prints a label bearing a QR code for the rocking chair from the website, and then when the parent scans the rocking chair, a lullaby selection is transloaded to the media player device to replay during rocking.

The scan-able code will include an access identifier which in the presently preferred embodiment comprises a Uniform Resource Locator. The method comprises transferring or downloading one or more data items received at the mobile device. The mobile device provides a platform to serve as a portal to a remote retrieval system. The remote retrieval system comprises a remote holding area for storing data items, a local device in communication with the remote holding area comprising an audio or video presentation portion stored therein. At the remote holding area, the audio or video presentation is retrieved upon access for downloading to the mobile device.

Advantageously, unlike a static content placed upon a hang tag at the time of manufacture, the placement of QR codes allows a content provider to constantly refresh the content with new and more recent media, each being based upon the latest respected research.

Additionally, given the small size and the relatively vast ability to carry long strings of data words, the variation of QR codes over a line of a single product can produce very well-tailored programs for specific ages and sizes. Consider that swaddling blanket can be sized for a newborn while another blanket, and consequently bearing a distinct QR code may be sized for a six month-old baby. Marking each with distinct QR codes directing mobile devices to distinct URLs will allow each parent to audit distinct advice as to the specific and appropriate needs of the child they are caring for or attempting to comfort. In another embodiment of the invention, a series of QR codes are presented for distinct aspects of infant care, nourishment, and meeting other needs of the infant.

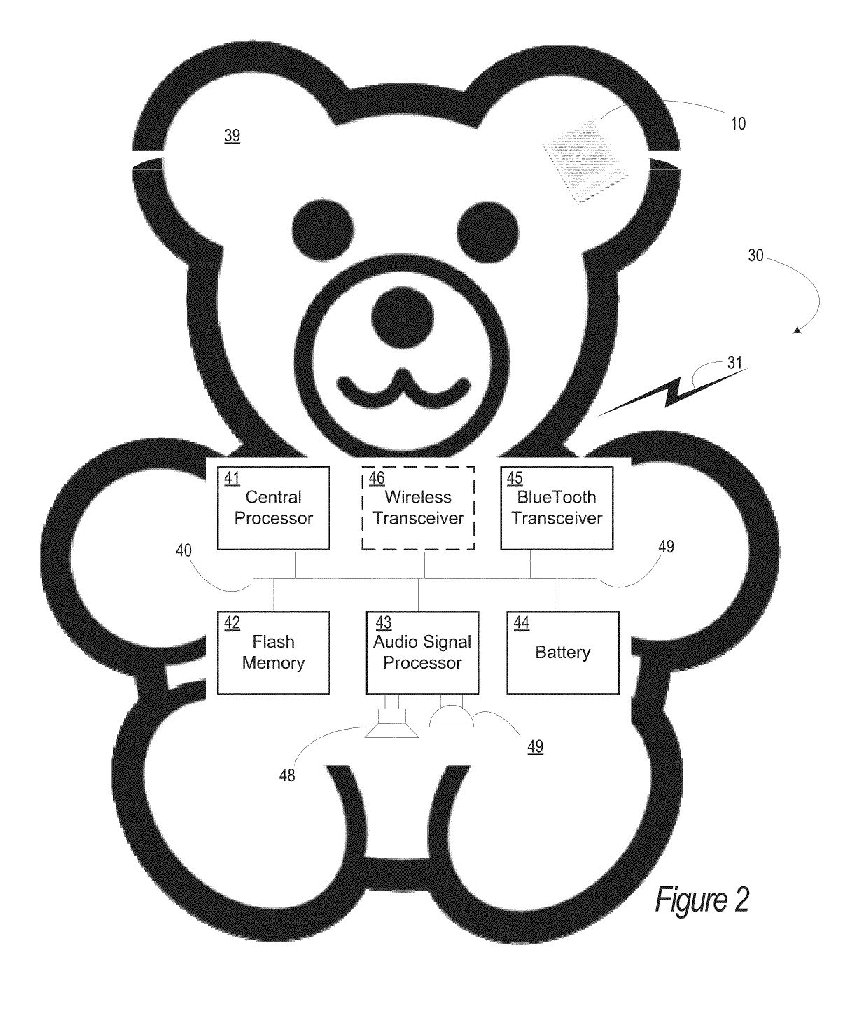

FIG. 2 depicts an exemplary plush toy 30 having a media player device 33 within it which, in turn, is selectively communicatively coupled by wireless means to a mobile device or other wireless device. While the discussion herein will enable this wireless link by Bluetooth™ it can be equally enabled by any of the IEEE 802.11 protocols or any wireless network technology that relies upon local area networks that allow distinct addressing of clients thereon for purposes of establishing and maintaining wireless communication within the network.

Bluetooth is a wireless technology standard for exchanging data over short distances (using short-wavelength radio transmissions in the ISM band from 2400-2480 MHz) from fixed and mobile devices, creating personal area networks (PANs) with high levels of security. Created by telecom vendor Ericsson in 1994, it was originally conceived as a wireless alternative to RS-232 data cables. It can connect several devices, overcoming problems of synchronization. Bluetooth was standardized as IEEE 802.15.1, but the standard is no longer maintained.

The 802.11 family consist of a series of half-duplex over-the-air modulation techniques that use the same basic protocol. The most popular are those defined by the 802.11b and 802.11g protocols, which are amendments to the original standard. 802.11-1997 was the first wireless networking standard in the family, but 802.11a was the first widely accepted one, followed by 802.11b and 802.11g. 802.11n is a new multi-streaming modulation technique. Other standards in the family (c-f, h, j) are service amendments and extensions or corrections to the previous specifications.

802.11b and 802.11g use the 2.4 GHz ISM band, operating in the United States under Part 15 of the U.S. Federal Communications Commission Rules and Regulations. Because of this choice of frequency band, 802.11b and g equipment may occasionally suffer interference from microwave ovens, cordless telephones and Bluetooth devices. 802.11b and 802.11g control their interference and susceptibility to interference by using direct-sequence spread spectrum (DSSS) and orthogonal frequency-division multiplexing (OFDM) signaling methods, respectively. 802.11a uses the 5 GHz U-NII band, which, for much of the world, offers at least 23 non-overlapping channels rather than the 2.4 GHz ISM frequency band, where adjacent channels overlap. Better or worse performance with higher or lower frequencies (channels) may be realized, depending on the environment. In either regard, the technology for wireless connection of a network is conventional and reliable and is hereby adopted, not to the exclusion of any other wireless network but, rather, for explanatory purposes to prove the enablement of the device.

As depicted in FIG. 2, media player device 30 comprises label 10 and resides on the exterior of a plush toy 39, selected to appeal to newborns or toddlers and configured to enclose entirely a specific purpose computer 40 organized about a central bus 49 providing communicative connection between the several components.

The media player device 30 includes a central processor 41 in communicative connection with the memory 42. In the presently preferred embodiment, flash memory modules. For purposes of the media player device solid state memory or solid state drives (SSD) serves both as random access memory (RAM) and as read-only memory (ROM), however more conventional configurations may be used to implement the embodiment.

Unlike magnetic hard drives, solid state hard drives have no moving parts and do not rely on magnetic fields to store data. Because they use electrical current, rather than motors and magnets, to store data, they can access data noiselessly and with less power consumption. Solid state drives are also not subject to the same physical damage from impacts or large magnetic forces, making them suitable for mobile computers.

Solid state hard drives use a series of transistors, pieces of silicone and semiconductors to transfer the electrical current. Each piece is microscopic and can be affected by the transfer of a few electrons. Like all data storage, solid state drives use binary, a series of 1s and 0s, to represent data. A 0 is represented by a transistor that cannot accept an electrical current, while a 1 is represented by one that allows the flow of electricity.

As the central processor 41 writes or deletes data from the drive, the information is converted by the program to binary data. This binary data is sent to the drive's writing center, where it is converted to electrical currents and used to realign the transistors. To read data, the read center of the drive sends a current through the portion that holds the data to be read and returns the sequence of 1s and 0s. This sequence is sent to the program and presented as information the central processor 41 can read. Advantageously, the elimination of distinct RAM and ROM allows for a simpler, more durable embodiment than might be possible with ROM functions being performed by a magnetic drive.

All programs for driving the media player device 41 are stored in the above-described nonvolatile memory and dedicate the central processor 41 working based upon the programs as a specific-purpose computer in the preferred embodiment. The programs stored are instructions for performing each of the functions set forth herein and such other functions as are appropriately configured to achieve the ends of the media player device 41 as described herein.

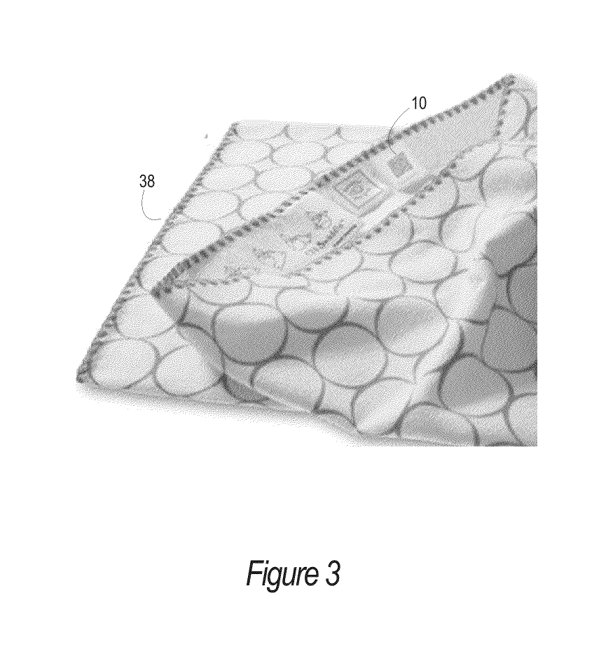

Additionally, the processor 41 is also connected to a wireless device, in this exemplary case, a Bluetooth™ transceiver 45. In an optional additional embodiment, a wireless transceiver is also included, and is selected to be an IEEE 802.11 transceiver enabling some form of WiFi addressing and communication as a client on a wireless network, such as that present in many homes and businesses and emanation from a wireless router 90 as shown in FIG. 3.

An audio processor 43 receives and sends signals from the central processor 41 in digital form and performs either a digital to analog conversion to generate sound through a connected speaker or speakers 48 or takes sound waves from a microphone 49 and turns them into digital signals by means of digital signal processors (DSP). In a broader sense, DSPs take real-world signals like voice, audio, video, temperature, pressure, or position that have been digitized and then mathematically manipulate them. A DSP is designed for performing mathematical functions like “add”, “subtract”, “multiply” and “divide” very quickly. Further, recording of sound can take place in a digital format and can be played through the speakers 48 in an audio format as is readily enjoyed by the newborn or toddler or to calm a crying, fussing baby.

Signals need to be processed so that the information that they contain can be displayed, analyzed, or converted to another type of signal that may be of use. Converters such as an Analog-to-Digital converter then take the real-world signal and turn it into the digital format of 1's and 0's. From here, the DSP takes over by capturing the digitized information on the memory 42 and processing it at the central processor 41. In playback the central processor 41 feeds the digitized information back to the audio signal processor 43 for replay as sound in the nursery. All of this occurs at very high speeds.

During the listening phase, analog audio is input through the microphone 49. This analog signal is then converted to a digital signal by an analog-to-digital converter and passed to the DSP. The DSP, in the preferred embodiment, performs MP3 encoding and saves the file to memory 42 for analysis by the processor 41.

Importantly, the microphone 49 and recording capability described immediately above are optional and are not necessary for the practice of the invention. Nonetheless, it is advantageous in various embodiments of the invention to use the microphone 49 in conjunction with analog to digital processing to enable an optional “baby monitoring” capability described below. Yet, even in the absence of this baby monitoring capability, the invention can be readily practiced for the purpose of soothing a newborn or toddler.

During the playback phase, a file is taken from memory 42, decoded by the DSP and then converted back to an analog signal through the digital-to-analog converter so it can be output through the speakers 48. In a more complex example, the DSP would perform other functions such as volume control, equalization and generate information to populate a user interface generated on the mobile device or other device 51 (FIG. 3).

Naturally, a power source is necessary. In the presently preferred embodiment, a rechargeable battery 44 is used. So that no contacts are present to present a hazard to a newborn or toddler, the presently preferred embodiment uses inductive charging for the battery, though this is not necessary for the practice of the invention. Inductive charging (also known as “wireless charging”) uses an electromagnetic field to transfer energy between two objects. This is usually done with a charging station. Energy is sent through an inductive coupling to an electrical device, which can then use that energy to charge batteries or run the device.

Induction chargers typically use an induction coil to create an alternating electromagnetic field from within a charging base station, and a second induction coil in the portable device takes power from the electromagnetic field and converts it back into electrical current to charge the battery. The two induction coils in proximity combine to form an electrical transformer. Power flowing through the transformer, thus formed, charges the battery 44 to provide power for the media player device 30.

A variety of techniques may be employed to implement and/or provide the components, modules, or functions of the media player device 30. For example, some or all of the functions may be implemented at least partially in firmware and/or hardware, including, but not limited to one or more application-specific integrated circuits (“ASICs”), standard integrated circuits, controllers executing appropriate instructions (e.g., microcontrollers and/or embedded controllers), programmable logic arrays (“PLAs”), field-programmable gate arrays (“FPGAs”), complex programmable logic devices (“CPLDs”), and the like. Some or all of the components and related data may also be stored as contents (e.g., as executable or other machine-readable software instructions or structured data) on a computer-readable medium. A computer-readable medium includes any medium, circuit, or substrate that is configured to store or represent information in digital or analog form in a manner that is readable by a computer processor, an electronic circuit, a physical device, or the like. Non-limiting examples of computer-readable media include volatile memory such as a RAM; read only memory such as a ROM, EPROM, EEPROM; flash memory; hard disks; portable media articles to be read by an appropriate drive or via an appropriate connection, such as a flash memory device; or the like. In typical embodiments, the stored contents of a computer-readable medium enable or configure one or more associated computing systems, devices, or circuits to execute, interpret, or otherwise process the stored contents to perform at least some of the described techniques. In some embodiments, the stored contents are instructions to be processed by a general purpose processor (e.g., a CPU). In other embodiments, the stored contents include data that is used to configure a reconfigurable logic circuit, such as a PLA, CPLD, FPGA, or the like. Some or all of the components and/or data structures may be stored on tangible, non-transitory storage mediums. The described computer program products may also take other forms in other embodiments. Accordingly, embodiments of this disclosure may be practiced with other computer system/device configurations.

Contextually selected QR codes add further utility to a preferred embodiment. In FIG. 2, the plush toy 39 bears a label 10 including one QR code. In FIG. 3, a second nursery accessory, a blanket 38 bears a distinct label and a distinct QR code. Further distinct labels can be placed upon any nursery accessory. The blanket 38 is just one non-limiting example of such a distinctly labeled nursery accessory. Others might include bottles, rocking chairs, playpens (each as discussed above), as well as specific toys such as a Busy Box™. Audio programming can be selected for each such context based upon labels the objects bear. In fact, a parent may print labels that would be affixable to listed accessories by logging on to a URL 83 where these are generated from codes stored in the database 85 and selected to evoke responsive audio programming consistent with the object to which the label is affixed.

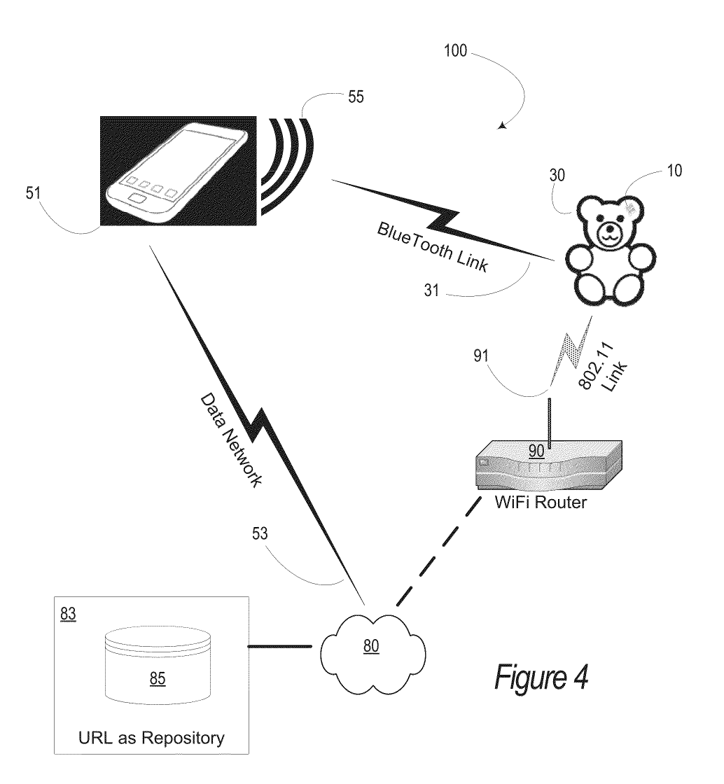

Referring now to FIG. 4, an example block diagram a system 100 which comprises the media player device 30 having the label 10 (each described above), as well as software instructions stored on a mobile device or other connected device 51. of a network management environment according to an example embodiment. In particular, FIG. 3 shows a network management environment 100 that, optionally, includes a router 90 to facilitate connectivity for the devices within a wireless local area network (LAN) and as a gateway to devices/systems outside of the user premises, such as a remote system. The local area network the router 90 supports may be a typical home network, provided by wire-based or wireless media but optionally includes a wireless link. The user premises may, optionally, also include multiple devices that are communicatively coupled to the local area network, including, for example, a desktop computer (not shown), a mobile device (every reference herein to a mobile device shall include, at least, a smart phone 51 (as shown), a tablet computer (not shown), a PDA), and a laptop computer (not shown). Other devices and/or systems may be connected to the router 90, including appliances (e.g., refrigerators, washing machines, hot tubs), lighting systems, security systems, digital video recorders, entertainment systems, and the like but they are neither necessary for the practice of the invention nor will they, under normal circumstances interfere with this optional embodiment.

Also, optionally, the router may provide a wide variety of other functions aside from supporting a LAN. For example, the router may facilitate direct control of the media player device 30, such as by forwarding commands or other data to a management interface (e.g., provided by a Web server within the wireless transceiver 46 (FIG. 2)). The router may also facilitate one or more of media player device 30 configuration backup and restore, firmware upgrades to the media player device 30, heartbeat monitoring through the microphone 49 and audio signal processor 43, and the like. For example, the wireless transceiver 46 (FIG. 2) may provide a control panel or other interface that is generated by application on a remote device connected to the router by a wide area network (WAN) such as the Internet that can be used by a user to configure, control, and otherwise manage the operation of the media player device 30 by accessing one or more functions of the central processor 41 (FIG. 2). Such a local interface or control panel may be made available via a Web server or similar component executing on the wireless transceiver 46 (every reference to Web server, herein refers to functions of the wireless transceiver 46 either alone or in conjunction with the central processor 41).

In some embodiments, the Web server within the wireless transceiver 46 may be deployed by or for a user or the manufacturer or distributor to provide either of content or maintenance of the media player device 30. In such embodiments, employees, agents, or contractors of the manufacturer or distributor, such as customer support representatives, help desk assistants, technicians, or the like, may access and use the media player device 30 via a remote management console and thereby to manage functions within the media player device 30.

In the preferred embodiment, a user will use the mobile device 51 to connect to the media player device 30. Once a connection is established, the mobile device 51 is used as a management console for the media device 30. In the presently preferred embodiment, the mobile device 51 generates a graphical user interface for driving the processor 41 (FIG. 2). Among the several functions are the selection of audio programming stored in memory 42 (FIG. 2) for play through the speakers 48 to soothe the newborn or toddler.

Additionally, the mobile device 51 can cause the storing of new audio programming from a URL 83 resident on a WAN such as the Internet in a database 85 accessible thereon. When the media device does download the audio programming material from the URL 83, it does so through at least one of two paths. In the presently preferred embodiment, the audio programming comes to the mobile device 51 when triggered by a command generated when the mobile device 51 scans the label 10 to decode the QR code thereon. The mobile device 51 then relays the information to the mobile device 51 which, in turn, sends it to the database 85. The database responds with specifically selected audio content which it sends to the mobile device 51, which, also in turn, the mobile device 51 transloads to the media player device 30 for replay. In the presently preferred embodiment, the mobile device 51 will first query the media player device to see if the noted audio programming is resident in memory 42 obviating the need for downloading from the database 85.

In an alternate embodiment, the mobile device 51, in response to scanning the QR code on the label, will instruct the media player device 51 to query the URL 83 for a download of the audio programming from the database 85, through the optional wireless transceiver 46, where present. In such instances, the user need not remain with the mobile device 51, in the communicative presence of the media player device 30.

Maintenance downloads of instructions from the database 85 may be used to reprogram the media player device 30 and would be available through either of the two described paths, where present.

Thus, in the preferred embodiment, the user (describe herein, alternately as the “harried parent”) may, in a nonlimiting example of operation of the invention, be holding and trying to console the newborn baby crying. (For purposes of clarity, there will be no mention of the WiFi alternate path for audio programming, it having been adequately described above, though this omission is not intended to suggest that the exemplary scenario is the sole means of operation.) Seizing a mobile device, the parent picks up the blanket 38, plush toy 39 or other nursery accessory each having a context-specific QR code and scans that code. In response, the mobile device, in one presently preferred embodiment, show on the graphic interface audio programming options selected for the context the QR coded conveys. With a deft move, the harried parent, summons up an application on the mobile device and quickly scans the label 10. In response, the mobile device 51, queries through the data network 53 the URL 83 to request a download of audio programming material such as, if the context suggests, soothing white noise. At the URL, a server reviews the most recent audio programming media earlier selected for replay by some conventional means and signals its identity to the mobile device 51 which relays that identity to the media playing device 30. If present in memory 42, the media playing device 30 will begin to replay the audio programming through the speakers 48. If not, the media playing device 30 will request the audio programming (and this can transpire through either of the two paths describe above), the mobile device 51 will transmit a request for download to the database 85 and will receive, in response, the audio programming. This programming it will relay to the media player device 30 for replay to the baby. All of this takes place within a few seconds and in response to two deft movements by the harried parent and all can be easily performed while holding the baby. Soon the child is asleep.

In an additional and optional embodiment, the media player device 30 will use the microphone 49 to sense noises in the room. In a further option, the audio signal processor will screen such noises as are sensed to determine if the noise represents crying or other distress noises. Still further embodiment listen for breathing or, where possible, heartbeat. When any of these noises indicate a need for parental intervention, or, in the absence of such recognition facility, simply are loud, the noise or some other form of alert is relayed by the media player device 30 to the mobile device 51 to replay or to trigger an alarm 55 indicative of the need for parental intervention.

While the preferred embodiment of the invention has been illustrated and described, as noted above, many changes can be made without departing from the spirit and scope of the invention. Accordingly, the scope of the invention is not limited by the disclosure of the preferred embodiment

What is claimed is:

1. A system for providing suitably audio programmatic material for enhancing a baby's experience in distinct contexts, the system employing a connected device having communicative access to a WAN and the connected device including a camera capable or reading a QR code and responding to instructions contained thereon, the system comprising:
a media player device including:
a central processor connected to a bus;
a memory for storing instructions and audio information in a nonvolatile form for the central processor to read through the bus and where instructions to execute;
an audio signal processor to produce sounds based upon audio information stored in memory; and
a radio transceiver to facilitate wireless communication with the connected device;
a label bearing a QR code, the QR code including a URL defined on the WAN and, upon scanning that QR code with the camera, causes the connected device to establish communication through the WAN to the resources located at the URL;
an instruction set stored in a nonvolatile format on nontransient memory in a mobile device, the instruction set configured to instruct the mobile device to communicate with the media player by means of the radio transceiver and when prompted by the instruction set, to store information in the memory the media player device comprises; and
the active page at the URL having access to a database containing audio programmatic material the connected device will retrieve for storage in the memory the media player device comprises.
